(19) United States
(12) Patent Application Publication
(10) Pub. No.: US 2010/0027957 A1
(43) Pub. Date: Feb. 4, 2010

(54) Motion Picture Reproduction Apparatus

(75) Inventors: Keisuke INATA, Ebina (JP); Mitsuhiro OKADA, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/429,482

(22) Filed: Apr. 24, 2009

(30) Foreign Application Priority Data
Jul. 30, 2008 (JP) 2008-195633

(51) Int. Cl. H04N 9/00; H04N 5/91

(52) U.S. Cl. 386/1; 386/108; 386/E05.003; 386/E09.001

(57) ABSTRACT

In a motion picture reproduction apparatus, a picture decoding unit decodes picture coded data read out of a storage unit and a reproduction information extraction unit extracts reproduction information such as motion vector, brightness and color difference information to utilize it as a parameter for selection of additional motion picture. An additional motion picture pattern production unit reads out an additional motion picture pattern associated with the reproduction information from an additional motion picture pattern storage unit and the additional motion picture pattern is combined with reproduced motion picture in a reproduced motion picture combining unit to be outputted to a monitoring unit through a display unit, so that additional motion picture different for each reproduction can be combined and displayed in accordance with the reproduced motion picture.

### INCORPORATION BY REFERENCE

The present application claims priority from Japanese application JP 2008-195633 filed on Jul. 30, 2008, the content of which is hereby incorporated by reference into this application.

### BACKGROUND OF THE INVENTION

The present invention relates to a motion picture reproduction apparatus and particularly to a system, method and device which can produce additional motion picture on the basis of reproduction information such as motion vector, brightness information and color difference information or record information such as zoom information, pan information and photographing date information recorded simultaneously with photographing time in a digital picture signal reproduction apparatus, for example, to combine it with reproduced picture to be displayed.

For example, the additional motion picture may be selected from a plurality of previously prepared patterns on the basis of the reproduction information or record information or may be selected from some selection items upon selection at random or may be automatically produced from reproduction information or record information in accordance with predetermined operation or may be produced by subjecting part of reproduced motion picture to predetermined operation or may be produced using the plurality of production means described above.

As a prior art of the technical field, for example, JP-A-7-288773 (page 1 and FIG. 1) may be referred to. In this publication, “object” is described as providing a video disk recorder and an optical disk having higher availability by recording picture, voice accompanying the picture and additional information except the voice and combining the additional information with the picture to be outputted and “configuration” is described as digitizing picture signal, voice signal accompanying the picture signal and additional information signal except the voice signal to compress the picture signal and the voice signal and to record the additional information signal and the compressed picture signal and voice signal onto a single optical disk 13 by means of an optical recording and reproduction device 12 and upon reproduction expanding the compressed picture signal and voice signal to combine the picture signal with the additional information signal and supply the additional information signal to part of a picture output device 21 together with the picture signal to output the voice signal to a voice output device 22.

Furthermore, as another prior art of the technical field, for example, JP-A-8-123977 (page 1 and FIG. 1) may be referred to. In this publication, “object” of the invention is described as relating to an animation system capable of moving character's mouth minutely in response to voice in real time and sometimes having the character make small gesture to perform action having a feeling of vitality, so that expressive real-time character animation can be attained and “configuration” is described as including voice analysis means M1 for analyzing inputted voice to get voice parameter, animation database M2 for previously storing therein picture information of character constituting animation, picture information getting means M3 for getting picture information from the animation database on the basis of the voice parameter and picture signal production means M4 for producing picture signal for animation display from the picture information gotten by the picture information getting means.

### SUMMARY OF THE INVENTION

In the above-mentioned prior arts, photographing information itself can be displayed as character or letter information upon reproduction, although animation or motion picture cannot be displayed in accordance with the situation of reproduced picture. Furthermore, only the same composite picture can be gotten for the same motion picture.

It is an object of the present invention to provide a motion picture reproduction apparatus having higher availability.

Accordingly, for example, picture coded data read out of a storage unit is decoded in a picture decoding unit and reproduction information such as motion vector, brightness information and color difference information is extracted in a reproduction information extraction unit to be utilized as a parameter for selection of additional motion picture. For example, an additional motion picture pattern production unit reads out additional motion picture pattern associated with reproduction information from an additional motion picture pattern storage unit and a reproduced motion picture combining unit combines it with a reproduced picture to be outputted to a monitor unit through a display unit.

Furthermore, for example, a plurality of different additional motion picture patterns associated with the reproduction information may be provided and random variable is produced in the additional motion picture pattern storage unit to select an additional motion picture pattern to be displayed from the plurality of additional motion picture patterns in accordance with the produced random variable, so that the additional motion picture is changed for the same picture coded data for each reproduction. The random variable may be reproduction date.

Moreover, for example, photographing information recorded together with the picture coded data upon recording may be used as the parameter for selection of additional motion picture. The photographing information contains zoom information, pan information and photographing date information by way of example.

According to the present invention, there can be provided the motion picture reproduction apparatus having higher availability.

Other objects, structure and effects except the above will be apparent from the following description of the embodiments taken in connection with the accompanying drawings.

### BRIEF DESCRIPTION OF THE DRAWINGS

FIG. 1 is a schematic diagram illustrating an example of a motion picture reproduction apparatus according to an embodiment of the present invention;

FIGS. 2A to 2C show an example of a composite motion picture of a reproduced motion picture and an additional motion picture in the motion picture reproduction apparatus shown in FIG. 1;

FIG. 3 is a schematic diagram illustrating another example of a motion picture reproduction apparatus according to another embodiment of the present invention;

FIGS. 4A to 4D show another example of a composite motion picture of a reproduced motion picture and an additional motion picture in the motion picture reproduction apparatus shown in FIG. 3;

FIG. 5 is a schematic diagram illustrating another example of a motion picture reproduction apparatus according to another embodiment of the present invention;

FIGS. 6A to 6D show another example of a composite motion picture of a reproduced motion picture and an additional motion picture in the motion picture reproduction apparatus shown in FIG. 5;

FIGS. 7A to 7F show other examples of composite motion pictures of reproduced motion picture and additional motion picture in the motion picture reproduction apparatus shown in FIG. 5;

FIG. 8 is a schematic diagram illustrating another example of a motion picture reproduction apparatus according to another embodiment of the present invention;

FIGS. 9A to 9D show other examples of composite motion pictures of reproduced motion picture and additional motion picture in the motion picture reproduction apparatus shown in FIG. 8;

FIGS. 10A to 10C show another example of a composite motion picture of reproduced motion picture and additional motion picture when brightness information is used in the motion picture reproduction apparatus of the embodiment shown in FIG. 1;

FIG. 11 is a schematic diagram illustrating another example of a motion picture reproduction apparatus according to another embodiment of the present invention;

FIG. 12 is a schematic diagram illustrating another example of a motion picture reproduction apparatus according to another embodiment of the present invention;

FIG. 13 is a schematic diagram illustrating another example of a motion picture reproduction apparatus according to another embodiment of the present invention;

FIGS. 14A to 14C show another example of a composite motion picture of reproduced motion picture and additional motion picture in the motion picture reproduction apparatus of the embodiment;

FIG. 15 shows an example of producing an additional motion picture pattern in the motion picture reproduction apparatus of the embodiment shown in FIG. 1; and

FIGS. 16A to 16C show another example of a composite motion picture of reproduced motion picture and additional motion picture in the motion picture reproduction apparatus of the embodiment.

### DESCRIPTION OF THE EMBODIMENTS

Embodiments of the present invention are now described with reference to the accompanying drawings.

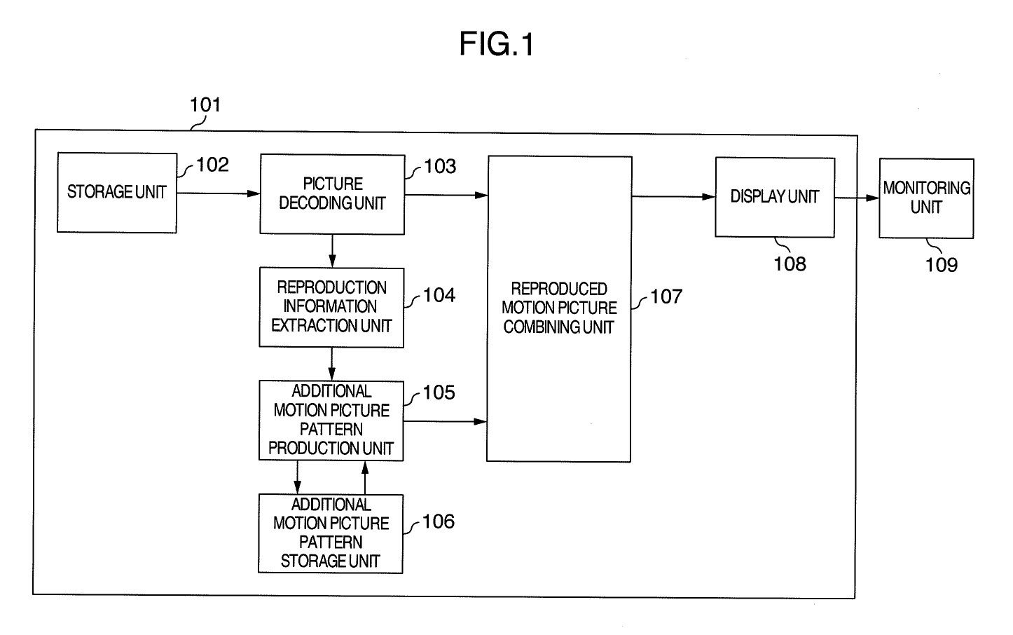

FIG. 1 is a schematic diagram illustrating a typical example of a motion picture reproduction apparatus according to an embodiment of the present invention.

In the motion picture reproduction apparatus 101 according to the embodiment shown in FIG. 1, picture coded data read out of a storage unit 102 is decoded by a picture decoding unit 103 and reproduction information such as motion vector, brightness information and color difference information is extracted by a reproduction information extraction unit 104 to utilize it as a parameter for selection of an additional motion picture. An additional motion picture pattern production unit 105 reads out an additional motion picture pattern associated with the reproduction information from an additional motion picture pattern storage unit 106 to combine it with a reproduced picture by a reproduced motion picture combining unit 107 and supply it through a display unit 108 to a monitoring unit 109.

A plurality of the different additional motion picture patterns associated with the reproduction information may be provided and random variable is produced in the additional motion picture pattern storage unit, so that an additional motion picture pattern to be displayed is selected from plural additional motion picture patterns in accordance with the produced random variable and the additional motion picture can be changed for the same picture coded data for each reproduction. The random variable may be reproduction date.

Moreover, title or reproduced motion picture can be analyzed to thereby select an additional motion picture pattern having higher correlation with a detected scene from plural additional motion picture patterns stored in the additional motion picture pattern storage unit in accordance with scene of reproduced motion picture.

For example, the sea is detected from pattern or design of the reproduced motion picture or title accompanying reproduced motion picture file, so that an additional motion picture pattern associated with the sea may be selected to combine it with the reproduced motion picture and display it.

Furthermore, the additional motion picture pattern production unit may use reproduction information, reproduced motion picture or pattern or design of the reproduced motion picture and produce the additional motion picture pattern instead of selecting a previously prepared additional motion picture pattern.

For example, when the sea is detected from pattern or design of the reproduced motion picture or title accompanying reproduced motion picture file, semitransparent blue background may be produced as additional motion picture.

Moreover, photographing information recorded together with picture coded data upon recording may be used as a parameter for selection of additional motion picture. The photographing information contains zoom information, pan information and photographing date information by way of example.

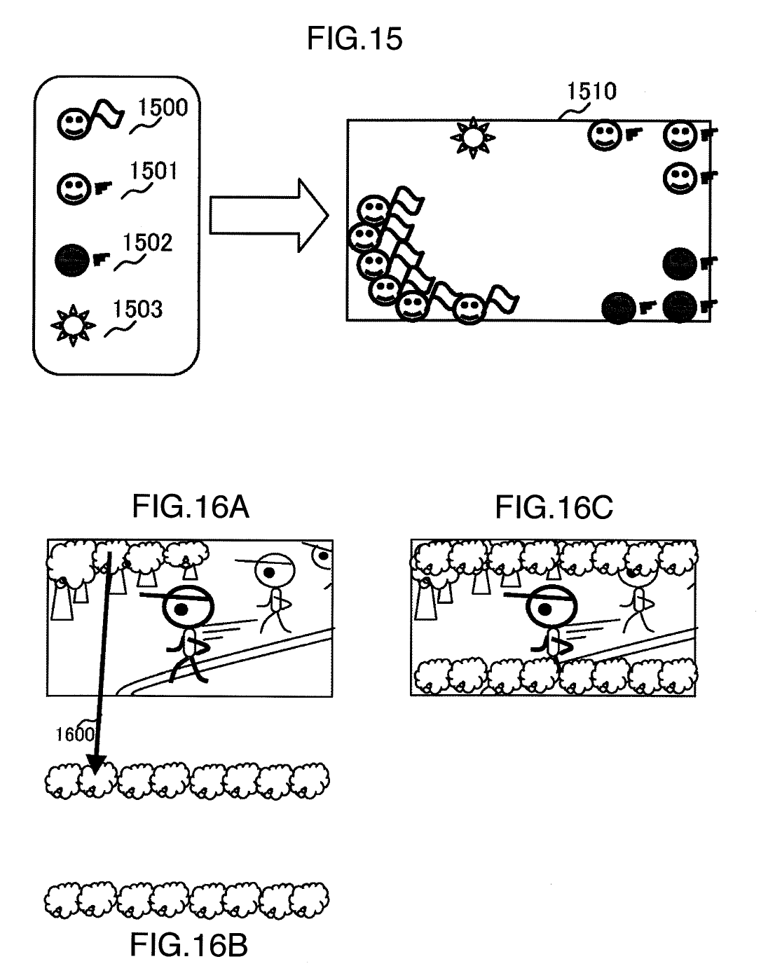

FIG. 15 shows an example of producing an additional motion picture pattern using a plurality of stored motion picture patterns 1500, 1501, 1502 and 1503.

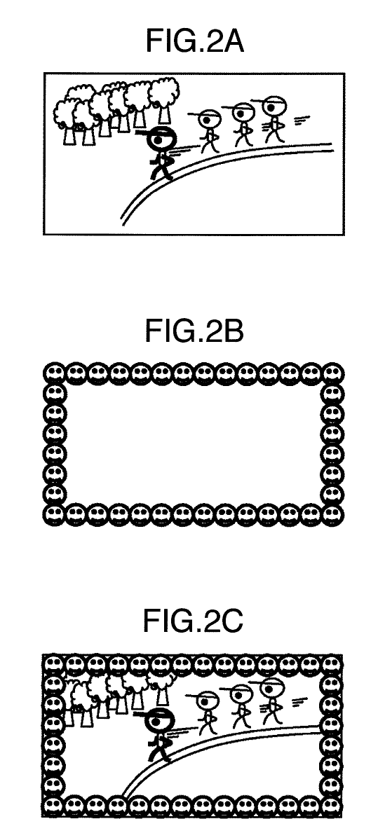

FIGS. 2A to 2C show an example of a composite motion picture of a reproduced motion picture and an additional motion picture in the motion picture reproduction apparatus shown in FIG. 1. FIG. 2A shows a reproduced motion picture, FIG. 2B an additional motion picture selected for the reproduced motion picture and FIG. 2C a composite motion picture of the reproduced motion picture and the additional motion picture. In this example, the additional motion picture constituting a frame of the reproduced motion picture is produced by small face patterns, although a plurality of face patterns may be prepared to be changed in accordance with reproduction information in real time, so that additional motion picture having small faces changed in accordance with reproduced motion picture may be combined therewith to be displayed. Furthermore, reproduction information, reproduction date or random variable produced by a random variable production unit may be inputted to change shape of eyes or mouth, profile of face, color of various parts or the like, so that additional motion picture may be changed in accordance with the situation to view composite motion picture with fresh spirits in each reproduction even when the same reproduction picture coded data is reproduced.

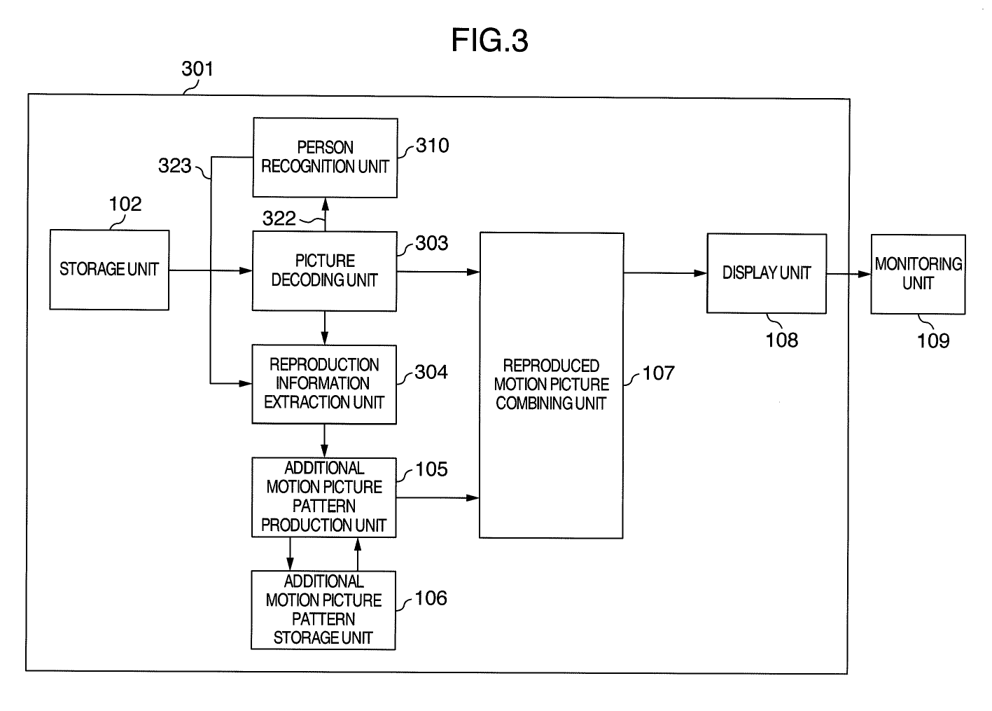

FIG. 3 is a schematic diagram illustrating another typical example of a motion picture reproduction apparatus according to another embodiment of the present invention.

In the motion picture reproduction apparatus 301 of the embodiment, a person recognition unit 310 is added to the motion picture reproduction unit 101 shown in FIG. 1. The person recognition unit recognizes person part in the reproduced motion picture on the basis of decoded information supplied from picture decoding unit 303 or reproduced motion picture to extract it and supplies area information showing person to reproduction information extraction unit 304. The reproduction information extraction unit 304 extracts motion vector in the area where person is shown. The reproduction information extracted from the area where person is shown may be information except the motion vector. In the embodiment, the extracted reproduction information can be used to produce additional motion picture pattern matching to position or movement of person.

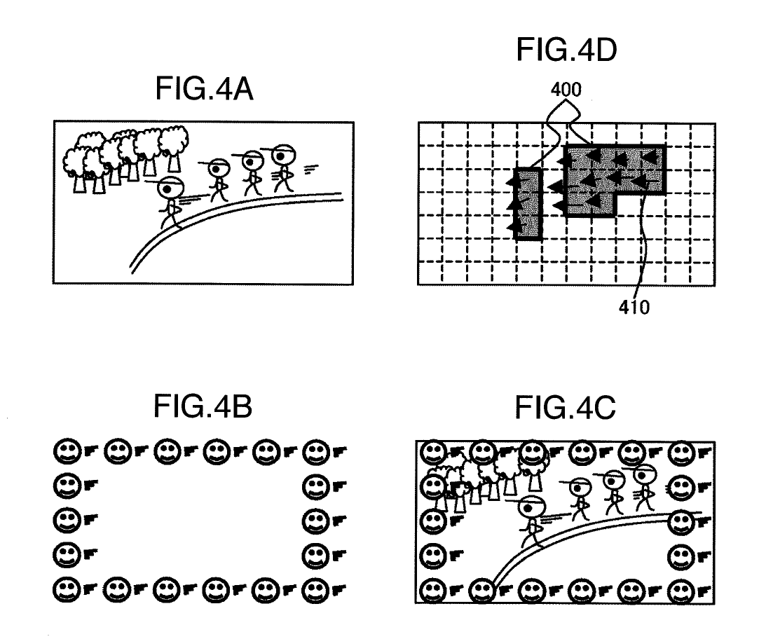

FIGS. 4A to 4D show another example of a composite motion picture of a reproduced motion picture and an additional motion picture in the motion picture reproduction apparatus shown in FIG. 3. FIG. 4A shows a reproduced motion picture, FIG. 4B an additional motion picture selected for the reproduced motion picture, FIG. 4C a composite motion picture of the reproduced motion picture and the additional motion picture, and FIG. 4D area information 400 showing person extracted by the person recognition unit and motion vectors 410 (indicated by arrows) in areas where person extracted by the reproduction information extraction unit 304 is shown. The additional motion picture pattern is not added to part being moved in a display screen, so that production of the additional motion picture pattern obstructing viewing can be prevented. Further, motion of the whole picture and size and movement direction of object to be photographed can be judged on the basis of movement of motion vector and the additional motion picture pattern can be selected in accordance with the situation.

A plurality of additional motion picture patterns may be combined to be displayed as additional motion picture.

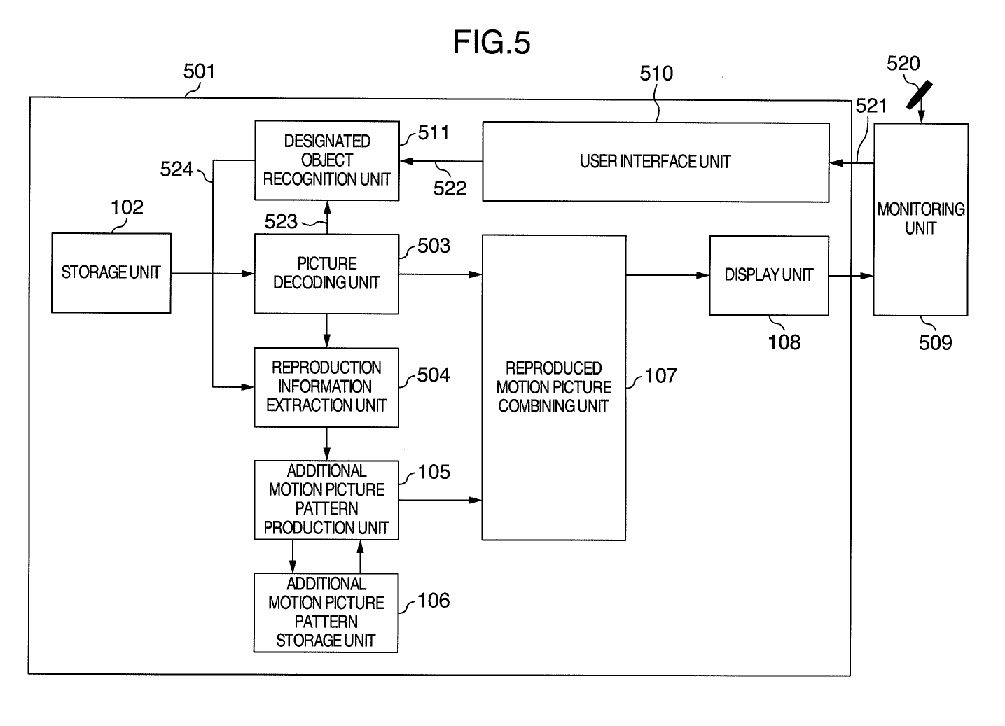

FIG. 5 is a schematic diagram illustrating another typical example of a motion picture reproduction apparatus according to another embodiment of the present invention.

In the motion picture reproduction apparatus 501 of the embodiment, a user interface unit 510 and a designated object recognition unit 511 are added to the motion picture reproduction apparatus shown in FIG. 1. The monitoring unit is of a touch screen type and supplies positional information 521 designated by an external device 520 to the user interface unit 510. The user interface unit 510 supplies positional information 522 to the designated object recognition unit 511. The designated object recognition unit 511 can recognize an object containing the positional information 522 and extract area information 524 of the object. After the designated object recognition unit 511 recognizes the object on the basis of the positional information 522, the designated object recognition unit 511 may identify movement of the object without using the positional information 522. Furthermore, movement of the object may be identified or detected by the reproduction information extraction unit 504 on the basis of reproduction information, for example, motion vector information. The extracted area information 524 of the object is supplied to the reproduction information extraction unit 504. The reproduction information extraction unit 504 extracts motion vector in the area of the object. In the embodiment, the extracted reproduction information can be used to produce additional motion picture pattern matching to position or movement of the object designated by means of the touch screen.

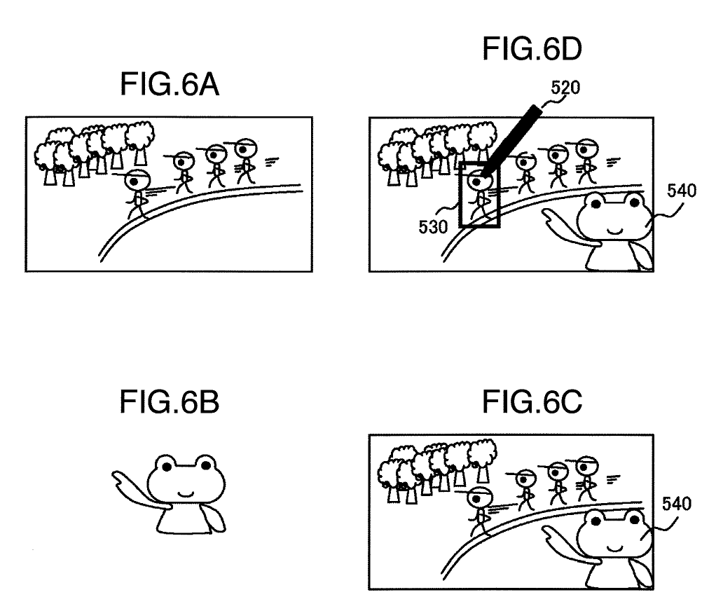

FIGS. 6A to 6D show an example of a composite motion picture of a reproduced motion picture and an additional motion picture in the motion picture reproduction apparatus shown in FIG. 5. FIG. 6A shows a reproduced motion picture, FIG. 6B an additional motion picture selected for the reproduced motion picture, FIG. 6C a composite motion picture of the reproduced motion picture and the additional motion picture, and FIG. 6D an area 530 of the object detected by designating part of the reproduced motion picture on the touch screen by means of the external device 520. In this example, a plurality of character patterns are stored in the additional motion picture pattern storage unit 106 and a character 540 indicating the extracted area 530 of the object is displayed. The character 540 may be disposed or displayed in part having less motion on the display picture to prevent viewing from being obstructed. The character may be moved in response to change of the area of the object and voice may be added thereto.

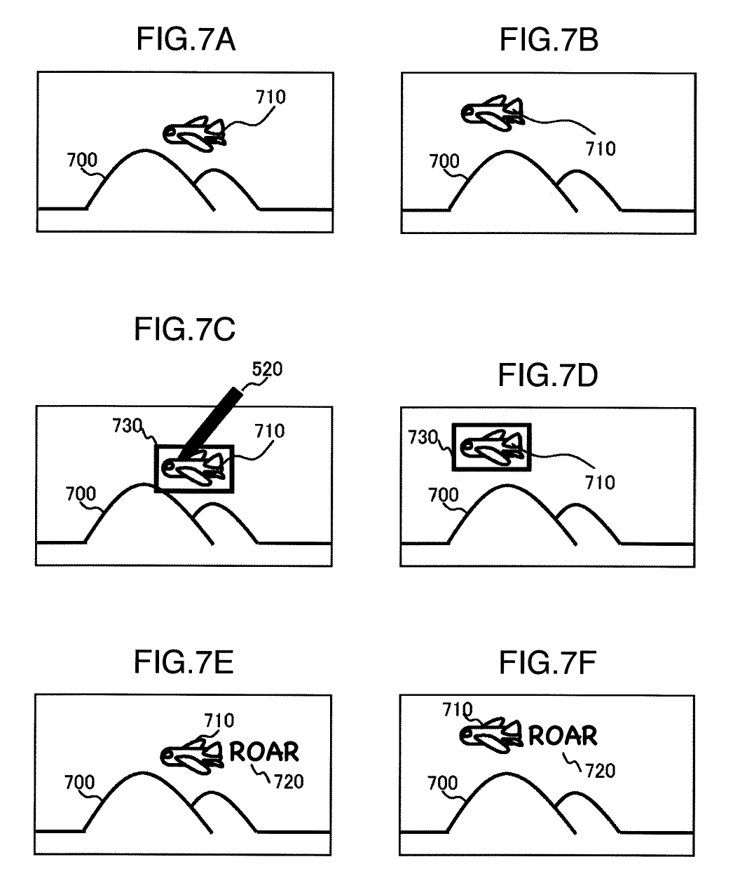

FIGS. 7A to 7F show examples of composite motion pictures of reproduced motion picture and additional motion picture in the motion picture reproduction apparatus shown in FIG. 5. FIGS. 7A and 7B show two reproduced motion pictures changed continuously from FIG. 7A to FIG. 7B. FIG. 7C shows an example of an area 730 of object detected by designating part of reproduced motion picture on touch screen by means of an external device 520. FIG. 7D shows the area 730 of the object moved in response to movement of the object recognized in FIG. 7C. The area of the object in FIG. 7D may be extracted on the basis of a motion vector of the object designated in FIG. 7C or on the basis of recognition of a shape of the object designated in FIG. 7C, for example. FIGS. 7E and 7F show examples of additional motion picture pattern 720 added to the extracted object.

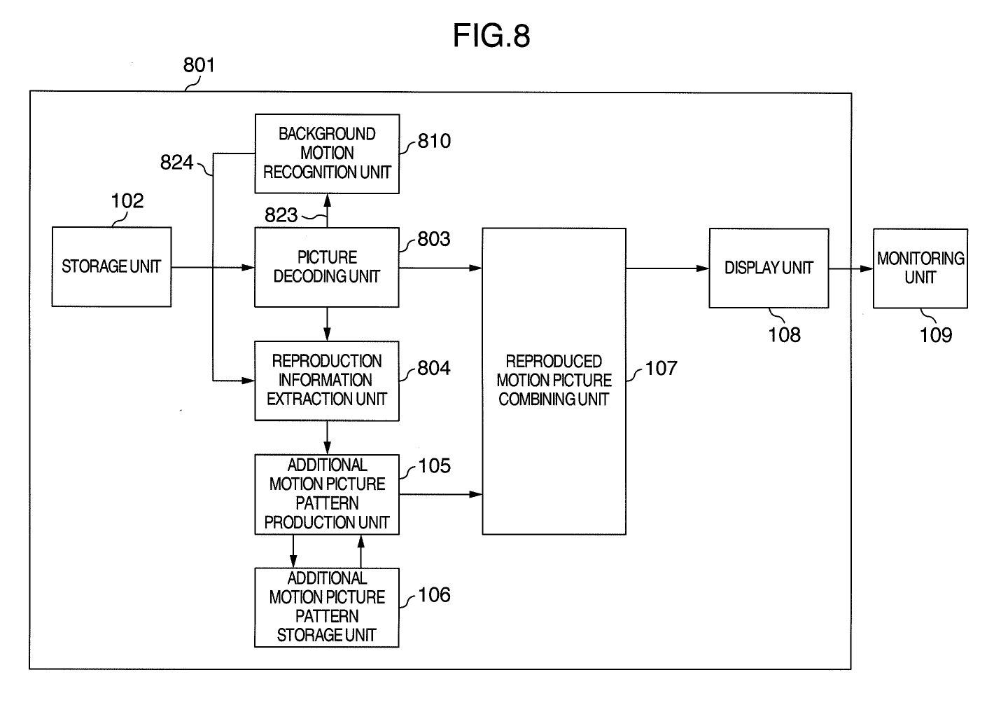

FIG. 8 is a schematic diagram illustrating another typical example of a motion picture reproduction apparatus according to another embodiment of the present invention.

In the motion picture reproduction apparatus 801 of the embodiment, a background motion recognition unit 810 is added to the motion picture reproduction apparatus shown in FIG. 1. The background motion recognition unit 810 recognizes background part in reproduced motion picture from decoded information supplied from the picture decoding unit 803 or the reproduced motion picture to be extracted and supplies area information representing background to reproduction information extraction unit 804. The reproduction information extraction unit 804 extracts motion vector in the area where the background is shown. The reproduction information extracted in the area where the background is shown may be any information except the motion vector. In the embodiment, the extracted reproduction information can be used to produce additional motion picture pattern matching to position or motion of background.

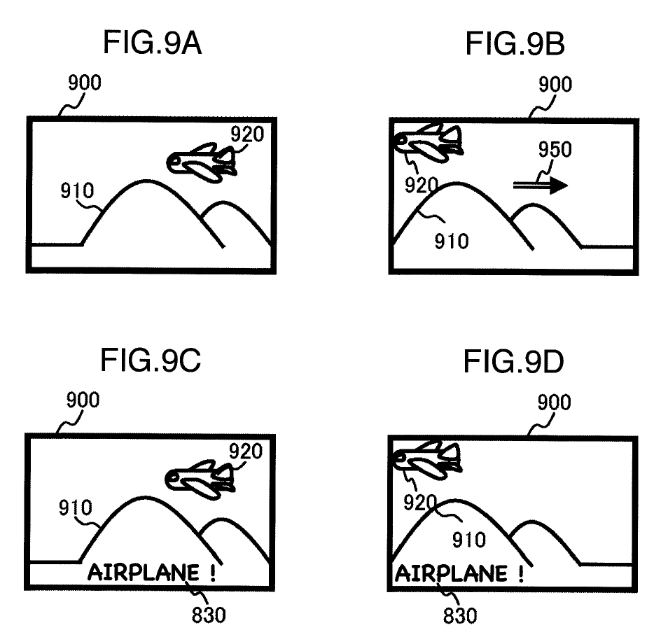

FIGS. 9A to 9D show examples of composite motion pictures of reproduced motion picture and additional motion picture in the motion picture reproduction apparatus shown in FIG. 8. FIGS. 9A and 9B show two reproduced motion pictures changed continuously from FIG. 9A to FIG. 9B. Motion vector 950 in FIG. 9B is to be extracted for background 910 instead of being extracted for object 920. FIGS. 9C and 9D show examples of additional motion picture pattern 830 added to the extracted background.

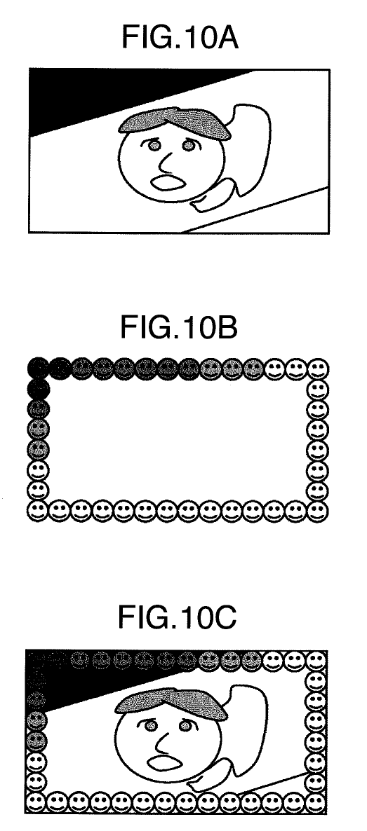

FIGS. 10A to 10C show another example of a composite motion picture of a reproduced motion picture and an additional motion picture when brightness information is used as reproduction information in the motion picture reproduction apparatus shown in FIG. 1.

FIG. 10A shows a reproduced motion picture, FIG. 10B an additional motion picture selected for the reproduced motion picture and FIG. 10C a composite motion picture of the reproduced motion picture and the additional motion picture. Since brightness at upper left part of the reproduced motion picture is low, brightness at upper left part of the additional motion picture is make low, so that the additional motion picture easy to view can be produced. A plurality of patterns of brightness or color difference may be provided or brightness or color difference may be changed by operation processing in accordance with reproduction information.

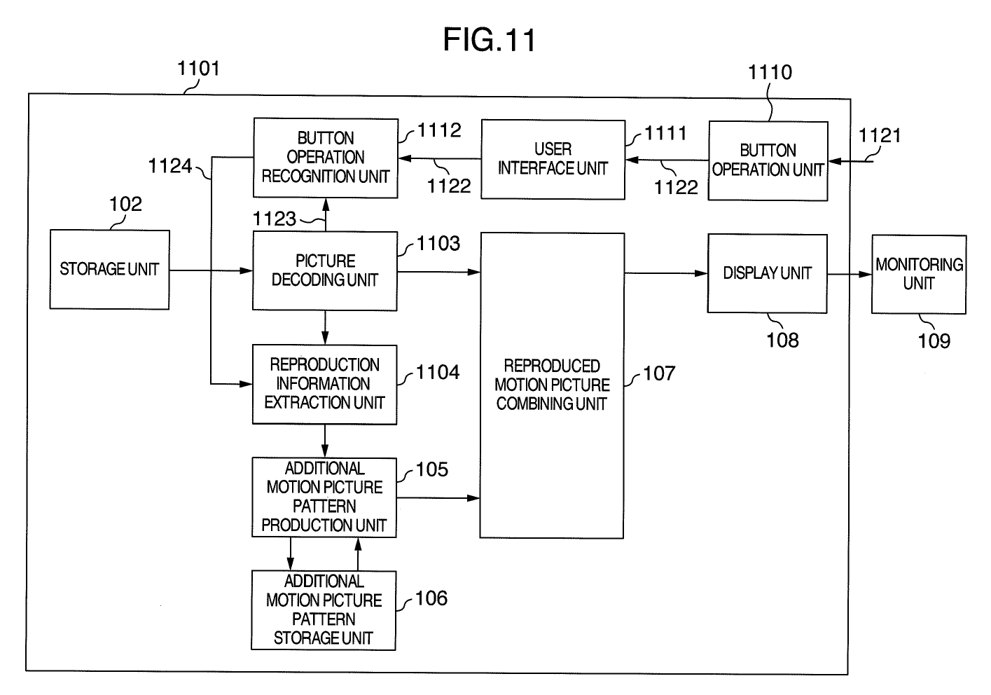

FIG. 11 is a schematic diagram illustrating another typical example of a motion picture reproduction apparatus according to another embodiment of the present invention.

In the motion picture reproduction apparatus 1101 of the embodiment, a button operation unit 1110, a user interface unit 1111 and a button operation recognition unit 1112 are added to the motion picture reproduction apparatus shown in FIG. 1. The button operation unit 1110 receives button operation 1121 inputted from outside and supplies button operation information 1122 to the user interface unit 1111. The user interface unit 1111 supply the button operation information 1122 to the button operation recognition unit 1112. The button operation recognition unit 1112 recognizes specific button operation pattern 1124 and supplies the button operation pattern 1124 to reproduction information extraction unit 1104. The reproduction information extraction unit 1104 treats the button operation information as part of reproduction information to thereby produce additional motion picture pattern in response to the button operation. As an example of input to the button operation unit, pressure information when button is pushed or binary information as to whether button is pushed may be used.

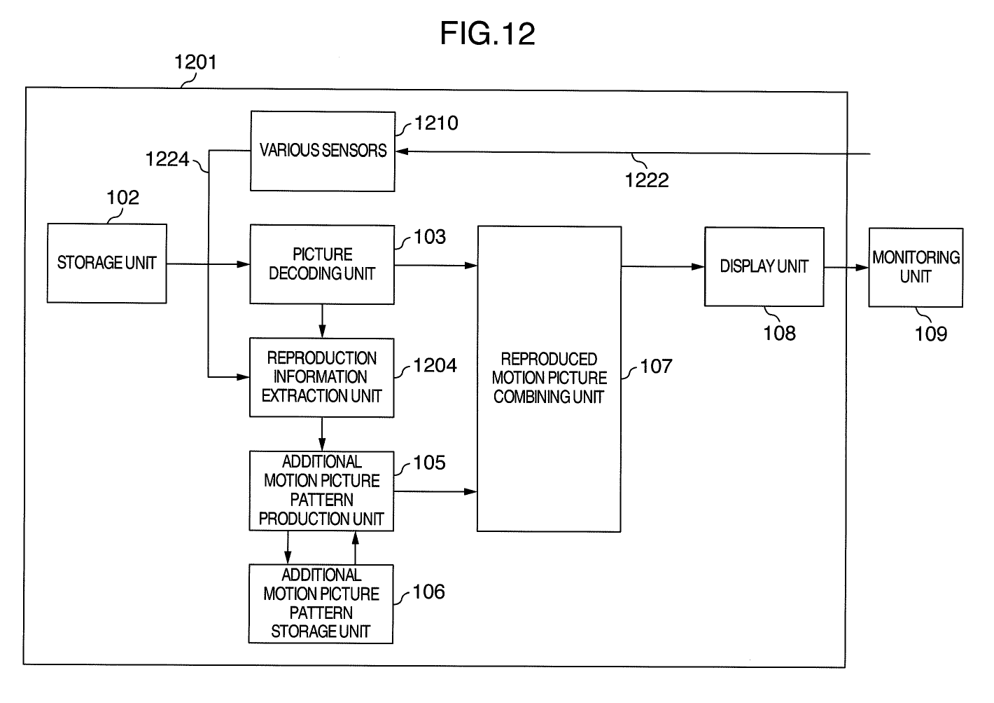

FIG. 12 is a schematic diagram illustrating another typical example of a motion picture reproduction apparatus according to another embodiment of the present invention.

In the motion picture reproduction apparatus 1201 of the embodiment, various sensor 1210 is added to the motion picture reproduction apparatus shown in FIG. 1. The various sensor 1210 contains, for example, inclination sensor, illumination sensor, acceleration sensor, sound sensor, impact sensor, pressure sensor and the like. The various sensor 1210 detects change 1222 in various states of reproduction apparatus and supplies the detected sensor information to the reproduction information extraction unit 1204. The reproduction information extraction unit 1204 can treat various sensor information as part of reproduction information to produce additional motion picture pattern in accordance with the various sensor information.

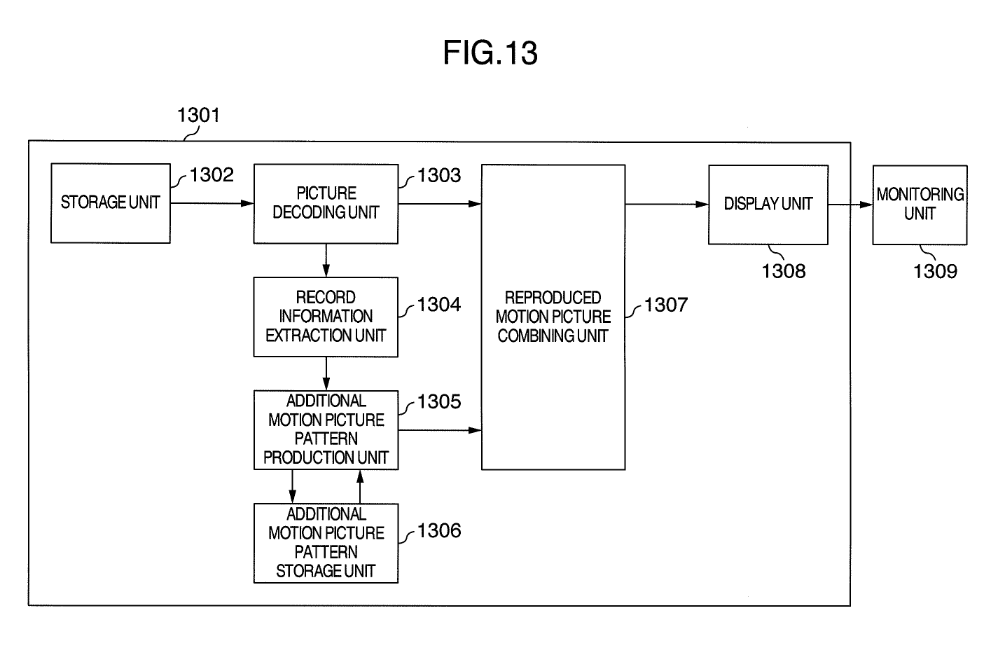

FIG. 13 is a schematic diagram illustrating another typical example of a motion picture reproduction apparatus according to another embodiment of the present invention.

In the motion picture reproduction apparatus 1301 of the embodiment, photographing situations such as zoom information, pan information, inclination information, photographing date information and temperature information are recorded as record information together with picture upon photographing by video camera or the like and the record information is used upon reproduction instead of reproduction information shown in FIG. 1.

In the motion picture reproduction apparatus 1301 of the embodiment, picture coded data and record information are read out of storage unit 1302 and picture decoding unit 1303 performs decoding and extraction of record information. Record information extraction unit 1304 extracts information required for selection of additional motion picture from the record information. Additional motion picture pattern production unit 1305 reads out additional motion picture pattern associated with the record information from additional motion picture pattern storage unit 1306. The additional motion picture pattern is combined with reproduced motion picture in reproduced motion picture combining unit 1307 to be outputted to monitoring unit 1309 through display unit 1308.

A plurality of different additional motion picture patterns associated with the record information may be provided and random variable is produced in the additional motion picture pattern storage unit, so that an additional motion picture pattern to be displayed can be selected from plural additional motion picture patterns in accordance with the produced random variable to thereby change the additional motion picture for the same picture coded data in each reproduction. The random variable may be reproduction date.

For example, additional motion picture patterns are provided for season and time zone. Various patterns for scenes where children make snowman, it snows thickly, it is fine in winter and there is dead tree under blue sky are provided for the daytime in winter. Further, there is provided pattern for Christmas. Photographing date for frame of motion picture being reproduced is gotten or calculated from photographing date and reproduction position information recorded as record information and additional pattern corresponding to the photographing date can be combined with reproduced motion picture to reproduce the combined or composite motion picture. Random variable is produced on the basis of reproduction date to select various additional pattern including snow pattern, so that different additional motion picture can be displayed every time even when the same coded data is reproduced.

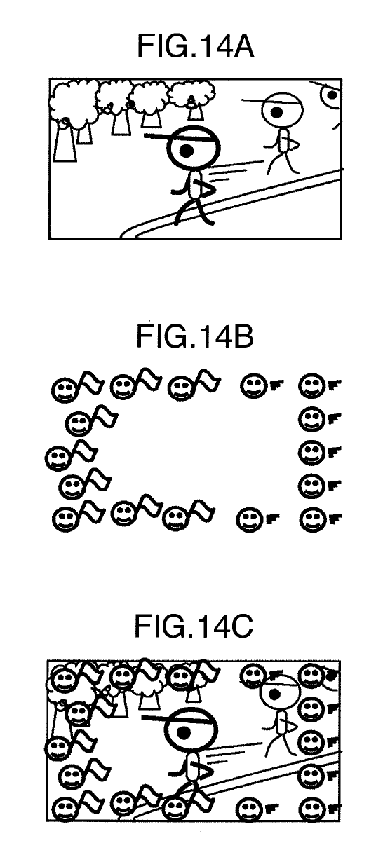

FIGS. 14A to 14C show another typical example of a composite motion picture of a reproduced motion picture and an additional motion picture in the motion picture reproduction apparatus of the embodiment.

In the embodiment, zoom information recorded upon photographing is used to select additional motion picture pattern by way of example. Additional motion picture is produced to be displayed in a combination with a face pattern as shown in FIG. 4C before zooming, although an object to be photographed is detected on the basis of zoom information and motion vector, so that face pattern in predetermined position for reproduced motion picture upon zooming as shown in FIG. 14A is changed as shown in FIG. 14B to thereby produce a composite motion picture as shown in FIG. 14C.

FIGS. 16A to 16C show another typical example of a composite motion picture of a reproduced motion picture and an additional motion picture in the motion picture reproduction apparatus of the embodiment. FIG. 16A shows a reproduced motion picture, FIG. 16B an additional motion picture pattern and FIG. 16C a display picture gotten by combining the reproduced motion picture and the additional motion picture pattern. In this example, tree pattern in the reproduced motion picture is used as reproduced motion picture information to produce additional motion picture pattern as shown by arrow 1600. Reproduction information or record information may be used to change shape or color of the additional motion picture pattern or to produce random pattern.

It should be further understood by those skilled in the art that although the foregoing description has been made on embodiments of the invention, the invention is not limited thereto and various changes and modifications may be made without departing from the spirit of the invention and the scope of the appended claims.

1. A motion picture reproduction apparatus comprising:
a storage unit to store therein recorded picture coded data;
a picture decoding unit to decode the picture coded data to produce reproduced motion picture;
a reproduction information extraction unit to extract reproduction information from the picture decoding unit;
an additional motion picture pattern storage unit to store therein additional motion picture pattern to be combined with the reproduced motion picture;
an additional motion picture pattern production unit to select additional motion picture pattern associated with the reproduction information from the additional motion picture pattern storage unit to read out it;
a reproduced motion picture combining unit to combine the additional motion picture pattern with the reproduced motion picture to produce composite motion picture; and
a display unit to display the composite motion picture in a monitor.

2. The motion picture reproduction apparatus according to claim 1, wherein
the additional motion picture pattern production unit produces the additional motion picture pattern using the reproduction information or the reproduced motion picture.

3. The motion picture reproduction apparatus according to claim 1, wherein
the reproduction information is a motion vector of the reproduced motion picture.

4. The motion picture reproduction apparatus according to claim 3, further comprising
a person recognition unit to recognize a person, wherein
the motion vector is a motion vector in an area where the person is recognized.

5. The motion picture reproduction apparatus according to claim 3, comprising
a designated object recognition unit to recognize during reproduction an object designated upon reproduction by user, wherein
the motion vector is a motion vector in an area where the object is recognized.

6. The motion picture reproduction apparatus according to claim 3, further comprising
a designated object recognition unit to recognize upon reproduction an object previously designated upon preview by user, wherein
the motion vector is a motion vector in an area where the object is recognized.

7. The motion picture reproduction apparatus according to claim 1, comprising
a background motion recognition unit to detect motion in a background, wherein
the reproduction information is information of motion detected in the background.

8. The motion picture reproduction apparatus according to claim 3, further comprising
a person recognition unit to recognize a person, wherein
the motion vector is a motion vector in an area except the area recognized by the person recognition unit.

9. The motion picture reproduction apparatus according to claim 1, wherein
the reproduction information includes brightness information or color difference information of the reproduced motion picture.

10. The motion picture reproduction apparatus according to claim 9, wherein
brightness, color difference or shape of the additional motion picture is changed in accordance with level of the brightness information or color difference information.

11. The motion picture reproduction apparatus according to claim 1, comprising
an operation button, wherein
the reproduction information includes information representing an event of pressing a button operated by a user.

12. The motion picture reproduction apparatus according to claim 11, wherein
the operation button comprises a pressure sensor and
the reproduction information includes a detection value of the pressure sensor for user's button operation.

13. The motion picture reproduction apparatus according to claim 11, wherein
the information of button is a kind of button selected by user or order of button operation by the user.

14. The motion picture reproduction apparatus according to claim 1, further comprising
a sensor to detect state of a reproduction device, wherein
the reproduction information is a detection value of the sensor.

15. The motion picture reproduction apparatus according to claim 14, wherein
the sensor is an inclination sensor, an acceleration sensor or an illumination sensor.

16. The motion picture reproduction apparatus according to claim 1, wherein
the reproduction information includes reproduction date information.

17. A motion picture reproduction apparatus comprising:
a storage unit to store therein recorded picture coded data and record information recorded upon coding;
a picture decoding unit to decode the picture coded data to produce reproduced motion picture;
a record information extraction unit to extract the record information;
an additional motion picture pattern storage unit to store therein additional motion picture pattern to be combined with the reproduced motion picture;
an additional motion picture pattern production unit to select additional motion picture pattern associated with the record information from the additional motion picture pattern storage unit to read out it;
a reproduced motion picture combining unit to combine the additional motion picture pattern with the reproduced motion picture to produce composite motion picture; and
a display unit to display the composite motion picture in a monitor.

18. The motion picture reproduction apparatus according to claim 17, wherein
the additional motion picture pattern production unit produces the additional motion picture pattern using the record information or the reproduced motion picture.

19. The motion picture reproduction apparatus according to claim 17, wherein
the record information includes zoom information, pan information or inclination information.

20. The motion picture reproduction apparatus according to claim 17, wherein
the record information includes photographing date information.

21. The motion picture reproduction apparatus according to claim 17, wherein
the record information includes information indicating an event of pressing a button operated by user upon recording.

22. The motion picture reproduction apparatus according to claim 17, wherein
the record information includes information representing force of pushing button operated by user upon recording.

23. The motion picture reproduction apparatus according to claim 21, wherein
the information of button is a kind of button selected by user or order of button operation by user upon recording.
